(19) United States
(12) Patent Application Publication
(10) Pub. No.: US 2012/0260313 A1
(43) Pub. Date: Oct. 11, 2012

(54) DIGITAL SYSTEM AND METHOD FOR BUILDING EMERGENCY AND DISASTER PLAN IMPLEMENTATION

(76) Inventor: Hector Gomez, Pasadena, CA (US)

(21) Appl. No.: 13/524,193

(22) Filed: Jun. 15, 2012

Related U.S. Application Data
(63) Continuation of application No. 11/996,528, filed on Jan. 23, 2008, now abandoned.

(51) Int. Cl. G06F 17/30; G06F 21/00

(52) U.S. Cl. 726/3; 707/609; 707/E17.032

(57) ABSTRACT

An emergency and disaster preparedness system is hosted on a computer system with a secure network interface using a terminal for user interface to the system communicates through the network interface. A security management module for user authentication connects an authenticated user into the system. A communications module provides and sets active alerts for all users. An administrative console provides management of system functions. A learning management system operable from the system incorporates a plurality of function specific databases for user information on the building structure, content and environs. A portable emergency response tool (ERT) operable independently or through the network interface is an integral portion of the system. The ERT has a portion of the plurality of function specific databases integrally stored thereon and functions specifically for use by first responders separate from or communicating with the overall system.

### RERERENCE TO RELATED APPLICATIONS

This application is a continuation of U.S. application Ser. No. 11/996,528 filed on Jan. 23, 2008 under 35 U.S.C. §371 based on PCT/US06/29329 having a filing date of Jul. 29, 2006 and claiming priority of U.S. provisional patent application Ser. No. 60/704,755 filed on Aug. 1, 2005 having the same title as the present application, all of which are incorporated herein by reference.

### FIELD OF THE INVENTION

This invention relates generally to the field of building operating and safety systems and more particularly to a digital system for emergency and disaster plan implementation including user training, communication and first responder capability.

### COPYRIGHT NOTICE

Certain software programs or routines disclosed in this application are subject to copyright protection and all rights thereto are specifically reserved. No dedication to the public of those copyrights is intended or made by such disclosure in this specification.

### BACKGROUND OF THE INVENTION

Modern commercial buildings are highly complex structures that employ sophisticated systems for operation. The size and complexity of the structures makes emergency preparedness for operators, occupants and government emergency first responders a huge task. Building systems including heating ventilating and air conditioning (HVAC), water and sewer, electrical and lighting, elevators, automated fire protection and security require extensive documentation and are subject to modification during the operational lifetime of the structure.

To accommodate emergency planning and preparedness for such structures, it is therefore desirable that a system be provided to document and present information on the structure and its systems to allow training of building operators on systems and emergency issues for the structure, training of first responders and training of occupants. It is desirable that the system incorporate remote portable capability for use by emergency first responders requiring detailed and up to date building information. Additionally, it is desirable that the system be able to simulate emergency situations for building administrators, operating engineers and first responder training specific to the structure allowing training without actual access to or impact on the building and its occupants. It is desirable that such training be directed and documented by the system to assure that training is adequate and accomplished. Finally, it is desirable that such a system provides for updating of system/inventory information on the structure to assure accurate real time information and to automate communication with system users for interaction on system/inventory changes, revised planning and training.

### SUMMARY OF THE INVENTION

An emergency and disaster preparedness implementation system incorporating the present invention is hosted on an integrated computer system with a secure network interface. At least one terminal for user interface to the system communicates through the network interface. A security management module is included in the system and receives communications from the terminal for user authentication and connects an authenticated user into the system. A communications module provides an active alert system of communications posted on the system for all users and provides means for setting an alert for a communication sent by a user. An administrative console for management of system functions is provided which is operable from the system by a user properly authenticated by the security management module. A learning management system is operable from the system by a user properly authenticated by the security management module, the learning management system incorporating a plurality of function specific databases for user information on all aspects of the building structure, content and environs.

A portable emergency response tool (ERT) operable independently or through the network interface is an integral portion of the system. The ERT has at least a portion of the plurality of function specific databases integrally stored thereon and functions specifically for use by first responders separate from or communicating with the overall system.

The integrated computer system further incorporates a content update and revisions module and an inventory management module interfaced to the LMS and operable from the at least one terminal by a user properly authenticated by the security management module.

### BRIEF DESCRIPTION OF THE DRAWINGS

These and other features and advantages of the present invention will be better understood by reference to the following detailed description when considered in connection with the accompanying drawings wherein:

FIG. 1 is a block diagram of the integrated system of the present invention showing the elements incorporated therein;

FIG. 2 is a block diagram of the management and administration element;

FIG. 3 is a block diagram of the building definition module;

FIG. 4 is a block diagram of the portable emergency response tool;

FIG. 5 is a block diagram of the system/user interaction;

FIG. 6 is a flow chart of the system update functions;

FIG. 7 is a flow chart of the learning tracking system for first responders;

FIG. 8 is a flow chart of the integrated communications element;

FIG. 9 is a flow chart of the inventory maintenance process; and,

FIG. 10 is a flow chart of the LMS Document Repository System.

### DETAILED DESCRIPTION OF THE INVENTION

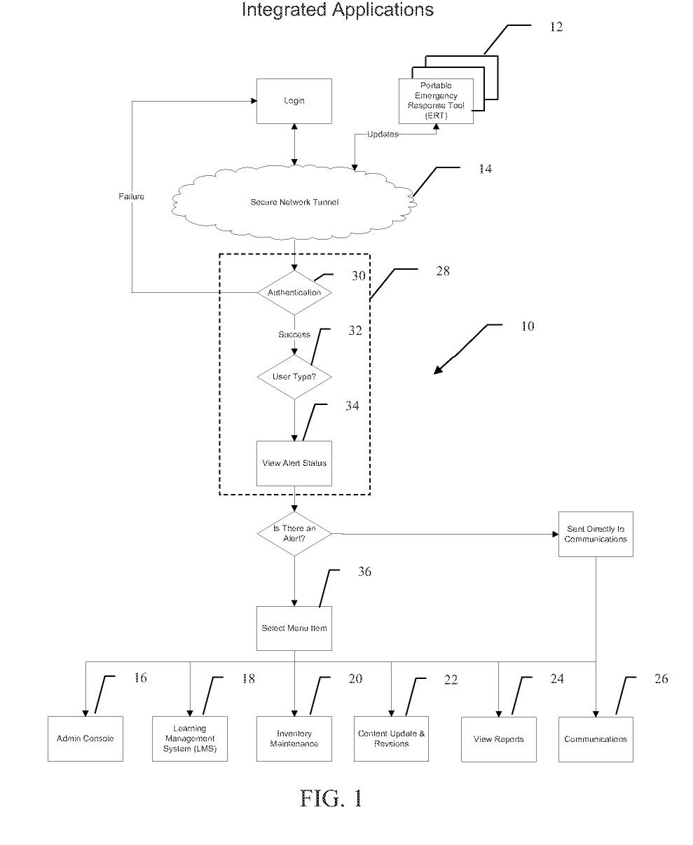

Referring to the drawings, FIG. 1 shows a block diagram of the basic modules of a system incorporating the present invention. The system 10 operates with both local and network connected elements. A number of portable emergency response tools (ERT) 12 which will be discussed in greater detail subsequently, form an integral portion of the system which operate independently but can be connected to the overall system via the interact or other appropriate network connection using a secure network tunnel 14 implemented in present enibodiments us VPN or SSL tunneling. Communication can occur via land based interact access or wireless access. Users other than first responders with ERTs communicate with the system through local or remote terminals as represented by terminal 16 which also communicate through the secure network tunnel.

The functional elements of the overall system include the administrative console 16, the learning management system (LMS) 18, the inventory maintenance system 20, the contents update and revision system 22, the report viewer 24 and the communications system 26.

The system of the present invention is designed to facilitate communications, training and interaction by a number of user types or groups. The overall system design and administration is initially defined and prepared by a system administrator. A number of customer types interact with the system at differing levels. For operations involving multiple buildings or properties, a super administrator has access to the system for all buildings properties. An interim level capability is provided for a regional administrator where the buildings or properties are located over a wide area and segregation of responsibilities or information is desirable. Similarly, for properties having more than one building or structure, a property administrator access level is employed. Customers within the environment of a building operating a system according the present invention are the building administrator, building engineers, building security and various building staff.

Interaction with the system by emergency first responders comprises a second user type for the system. As will be described in greater detail subsequently with respect to the ERT, fire officials and law enforcement officials interact with the system for training, compliance and actual response conditions. Within each type of agency, multiple levels of system access and interaction are accomplished.

Contractors or vendors for the building are allowed limited access to the system for purposes of location identification or systems information for performing services within the building.

Finally, the system interacts with various entities for compliance confirmation on training. Organizations such as insurance companies can access the system or be provided with reports confirming training of building administration and staff as well as first responder. Additionally, first responder unions with similar access capability can confirm union member training requirements.

Returning to FIG. 1, a user operating a terminal or ERT logs on to the system which employs a security management system 28 which includes an authentication module 30 and a user type identification module 32 for determining user permissions and access rights, encryption levels associated with data to be accessed, content which will be allowed to be accessed and maintaining audit logs for the user. During login, the system confirms the user authentication and identifies the user's privileges and group membership. Biometric validation of fingerprint or user token is incorporates in various embodiments of the system for two factor or three factor identification of a user as an element of the security management system. An alert status module 34 is invoked to determine if alerts applicable to the user are present, as will be discussed in greater detail with respect to the communications system. If applicable alerts are present, the user is routed directly into the communications system. If alerts are not present, the system presents the user with appropriate menu options 36 and relevant system based on the user and business information such as current building news or events.

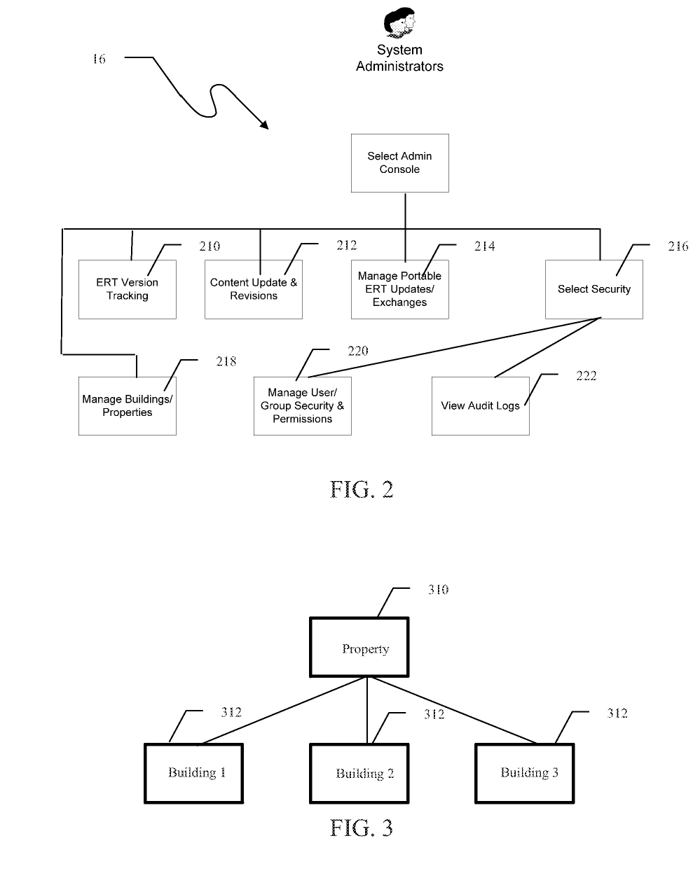

For appropriate permissions, the Administrative console (Admin console) is available through the menu. As shown in FIG. 2, the admin console provides modules for control of ERT version tracking 210 to assure that ERTs interacting with the system or to be used by first responders in emergency situations are consistent with the system configuration. Each ERT is tracked by version number and other relevant information such as dates associated with certain user actions such as last viewed, updated or deleted. A content update and revisions module 212 allows administrators to update the data in the system as required. A portable ERT manager 214 allows updates/exchanges of portables based on data from the ERT version tracking and content update and revisions module. Such updates/exchanges are noticed through the communications system with appropriate alerts for user action.

Also within the admin console, a security module 216 allows the administrator to view, input and modify user permissions and access rights, encryption levels associated with data to be accessed and content which will be allowed to be accessed. Creation of user types and groups are accomplished within the security module.

For systems employed at a region or property level, a building management module 218 allows the administrator to tailor the effect of the other admin console modules specific to a property or building. As represented in FIG. 3, the system is oriented hierarchically for management of regions including properties 310 and individual buildings 312.

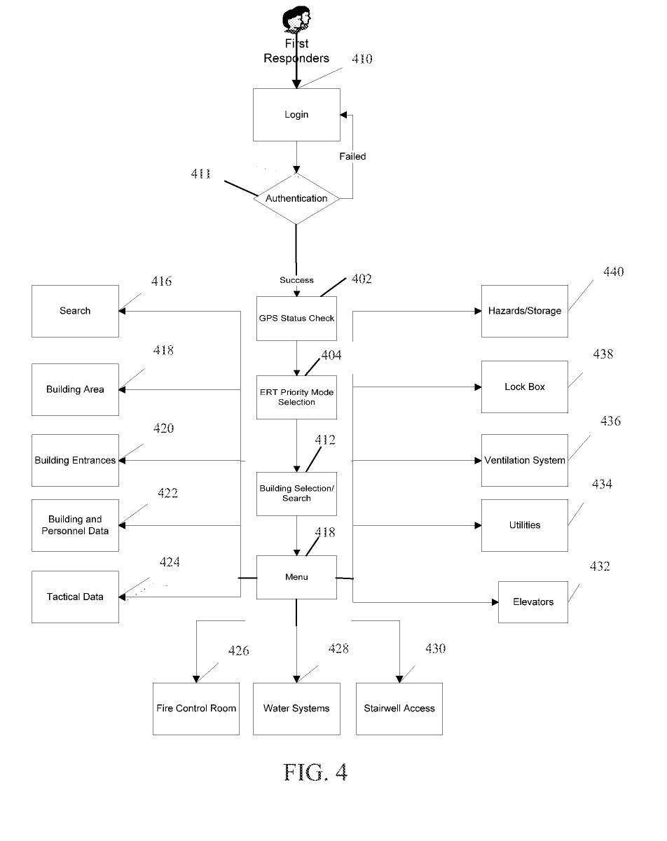

The ERT is an integral element of the overall system but provides a completely self contained portable tool. Various embodiment of the invention employ portable computers or handheld devices which may include communication capabilities such as embedded cellular phone systems. The functions of the ERT are simulated within the system to allow training as will be described in greater detail subsequently with respect to the Learning Management System. The ERT provides a means for all of the critical data contained in the system to be physically and directly available to a first responder in an emergency situation. Multiple ERTs can be provided to each First Responder organization such as fire departments and police. As shown in FIG. 4, a User authenticates entry in to the system as contained within the ERT using a login procedure 410 with two or three factor authentication 411 involving username, password, token, and/or biometric scanning.

The system checks if GPS capabilities are enabled and functioning 402. If GPS capabilities are enabled, the system adjusts its inputs and outputs to provide specific location related options to the user. The system requests the user to select the Priority Mode 404. If user selects a Priority Mode, the system streamlines all input options and output displays to increase both response time and relevancy to specific emergency situations. Examples of Priority Modes can include structural fire, occupant evacuation, hostage situations, etc. Priority modes are customizable.

The system provides building selection module 412 which provides a list of buildings covered as well as a map with selectable icons pertaining to each building. The user can either select the building off the map or the list to drill down for more information. The system provides search function to identify buildings based upon user defined parameters. The system presents an initial menu screen 414 through which the user can access various modules present in the ERT. If the system is GPS enabled, system will display current location of system on map and automatically default to location building.

As a basic component the system provides a search tool 416 with a global search capability to quickly search through all the data within the system. Search parameters are user defined. The system offers certain filters and sorting capabilities such as sorting by date or searching within specific geographic regions.

For geographic orientation of the user, the system provides a building area module 418 with zoom-able aerial/satellite image of the building and surrounding environs which can be rotated and manipulated for enhanced viewing options. The system also provides information regarding location such as address, cross streets, and proximity to highways. For application in law enforcement first responder scenarios, the system highliats potential high risk targets around the building such as consulates, government entities, corporate headquarters, hospitals, hotels/resorts, malls, tourist attractions, military bases, hazardous waste sites, landmarks, power plants, nuclear plants, airports, sea ports. If the system is GPS enabled, the system can display specific options to center upon the system's coordinates. The system can also present specific location related options based upon the GPS coordinates such as exact travel routes, specific structural information, or calculated risk factors depending upon the Priority Mode.

As a specific location assistant, the system includes a building ingress/egress module 420 which presents a zoom-capable graphic of the floor plan of the building that highlights entrances. Textual descriptions of the entrances are also provided. Upon selecting a specific entrance the system provides a virtual tour that leads to critical locations inside the building, i.e., the fire control room. The virtual tour incorporates digital images of the actual building interior and exterior.

To assist the user in navigation within the system and allow rapid access to critical data in emergency situations, the system incorporates multiple dedicated subject databases. These databases employ relational database interaction to avoid duplicate data storage in the embodiment disclosed herein however individually structured databases in certain alternative embodiments are employed for system simplicity.

As examples for a current embodiment, the system provides a specific building and personnel information database 422 that incorporates such as critical contact and building information. Contacts include security and engineering personnel. Building information includes structural information such as the construction type (concrete, wood frame, etc.), the number of floors, units, site area, buildings on the property, exits, stairwells, and elevators. Building population broken down by day and night time is also provided. The system highlights information, names and floor location of “critical tenants.” Critical Tenants would include high risk tenants such as consulates, company headquarters, or government entities.

Again for assistance in geographic orientation of the user, the system includes a tactical database 424 that presents detailed street map of building and surrounding environs. The user can select specific information relevant to either fire or police department use. Fire department information covers information pertaining to fires and explosions while police information covers sniper or hostage confrontations. These elements can be specifically tailored through input by the first responders as defined in the communications module description. The user can select various emergency isolation zone perimeters with varying radius (e.g., 200 ft, 2 city blocks, ¼ mile). Upon selecting a perimeter the system identifies possible reasons for using that size perimeter, specific street level boundaries of the perimeter, as well as potential staging areas and command posts. The system can also provide on the map specific locations of notable community landmarks such as fire and police stations, hospitals, and schools. Selecting landmarks on the map provides detailed information about the landmark including contact information. Department specific guidelines and regulations are incorporated into the system to provide detailed information on how to handle specific emergencies such as fires, a hostage situation, and other emergency situations. Images provided include both street maps and satellite images. If the SYSTEM is GPS enabled, the SYSTEM can display specific options to center the floor plan upon the SYSTEM's coordinates. The SYSTEM can also present specific location related options based upon the GPS coordinates such as exact escape routes, specific structural information, or calculated risk factors depending upon the Priority Mode.

In a specialty facilities database 426, system provides detailed information regarding, for example, the building's fire control room. The system provides both the control room identified on a floor plan of the building and a virtual tour of the path to the control room incorporating digital images of the building. Virtual tours convey how to reach the control room from each of the building's entrances. Using digital images the system conveys information about the various emergency response related equipment—such as the fire alarm panel, PA system, fire alarm enunciator, elevator control panel, ventilation controls, and diesel emergency generator panel. The graphical information provided includes both the layout and location of control panels within the room. Each critical function in the control panel is labeled describing their purpose. In addition the system integrates simulation capabilities to aid or to train in the practical use of the equipment. The simulation capabilities allow the user to select specific switches and areas for detailed information regarding that switch or panel area. Images and instructions are maintained current through the content update and revisions modules to prevent any user confusion during emergency response.

A water systems database 428 in the system provides detailed information pertaining to the building's water systems. This includes but is not limited to the control valves, fire department connections, fire hydrant, fire pumps, sprinkler valves, standpipe valves, sump pumps, the water main, and water tanks. For each system covered, detailed information such as location, floor plans, digital images, simulation, and textual data are provided.

The system provides a stairwell database 430 with detailed information regarding all stairwells in the building. This information includes stairwells identified on floor maps, virtual tours, and textual data. The user can select specific stairwells to see a 3-D graphical representation of the stairwell within the framework of the building. This representation conveys the path, location, relative position to other stairwells within the building's 3-D framework, and relative position to exterior reference points such as cross streets.

The system provides an elevator database 432 with detailed information regarding all elevators in the building. Elevator locations are provided on interactive floor maps. The user can select specific elevators. The system responds with specific information (graphical and textual) regarding the selected elevator.

The system provides detailed information regarding building systems related to utilities in a utilities database 434. This includes but is not limited to gas shutoff valves, electrical control panels, and emergency generators. The information provided for each system includes digital images as well as locations mapped on a floor plan. Both the floor plan and the images are interactive to allow the user to select specific areas for more information.

The system provides detailed information regarding building ventilation systems in a HVAC database 436. The information provided for each system includes digital images as well as locations mapped on a floor plan. Both the floor plan and the images are interactive to allow the user to select specific areas for more information.

The system provides detailed information regarding procedures relevant to the specific type of property covered in a property procedures and structures database 438. For example, if the property is a nuclear plant, specific property type procedures would include radiation mitigation guidelines. Or if it is a hospital the specific property type procedure may include biological waste disposal guidelines and medical ventilation requirements. Specific property type structures would include such elements as seismic reaction systems, foundation and tunnel structures, and buckling/torsional collapse data.

The system provides detailed information regarding hazard zones within the building in a Hazards storage database 440. The information provided for each zone includes digital images as well as locations mapped on a floor plan. A 3-D graphical representation of the building allows the user to select individual floors. The system then provides an interactive detailed floor map to identify specific chemical or biological hazard zones within the floor. When a specific hazard on the floor map or map legend is selected, detailed information regarding that particular hazard is provided. This information may include facts such as steps for emergency treatment, symptoms and warning signs of exposure, and proper disposal guidelines.

The user interface for the ERT employs standard visual image and graphics are included in all relevant modules.

If the system is GPS enabled, the system can display specific options to center upon the system's coordinates. The system can also present specific location related options based upon the GPS coordinates such as exact travel routes, specific structural information, or calculated risk factors for each of the previously described subsystems depending upon the Priority Mode.

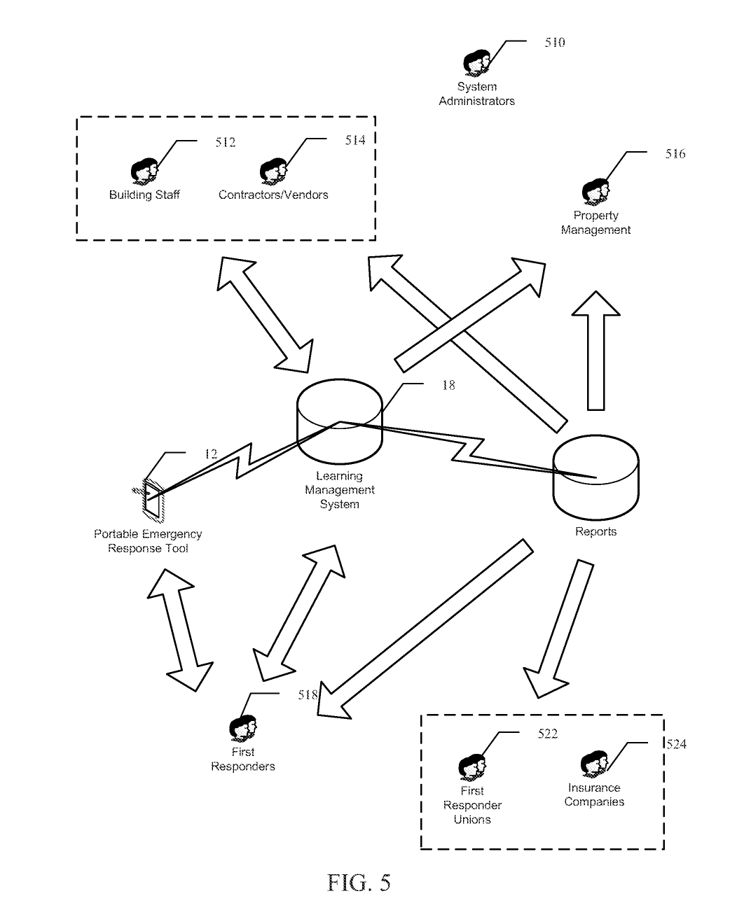

Another integrated element of the system is the Learning Management System (LMS) 18. As shown in FIGS. 5-7, the LMS is a multifaceted tool which integrates input and provides output to the various users. Various embodiments employ instant messaging capability, e-mail and voice over IP (VoIP) capability for real time interaction with the system by ERTs. FIG. 5 shows the relevant interactive communications flow for the various users. Controlled by the system administrators 510, the LMS provides training and data output to the building staff 512 and contractors/vendors 514 as well as property management 516. These users can, in turn provide inputs on changing procedures, conditions or inventory, as will be described in greater detail subsequently. Similarly, first responders 518 can interface to the LMS through the ERT or directly through network terminals for data review and training while providing input on procedural requirements and tactical data for the tactical database as previously described. The LMS interacts with the report generation module 24 which provides compliance and monitoring reporting information to all users including insurance company users 520 and first responder unions 522.

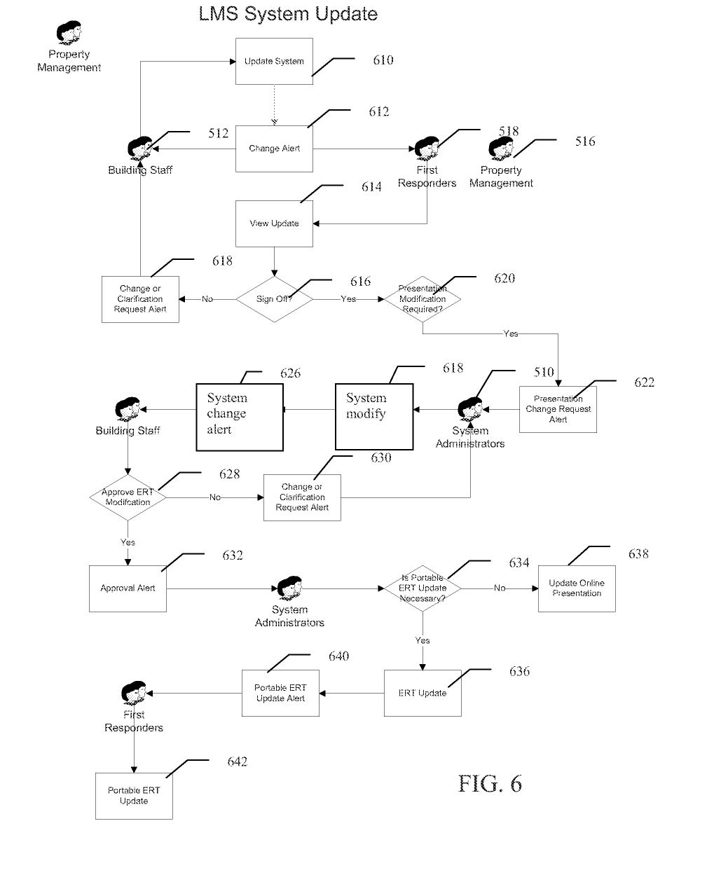

FIG. 6 demonstrates the interaction by users with the system to effectuate system updates with the LMS. Building Staff updates 610 the system by adding or modifying building relevant data such as building inventory (e.g., water main valves, control panel, or HVAC system).

The system sends alerts 612 to appropriate members of Building Staff, Property Management, and First Responders. First Responders view the updates 614 on the system and either sign off 616 to complete the system update or create a request or clarification request 618. If sign off is complete, system notes if a presentation modification is necessary 620. Otherwise the process is complete.

If a presentation update is necessary, the system sends a change request alert 622 to the System Administrators. The System Administrators modify the presentation and record the update status on the system. Upon completion, the system sends an alert 626 to the Building Staff.

Building Staff either approves the update 628 or sends a change/clarification request 630 to the System Administrators. If approved, an approval alert 632 is sent to the System Administrators.

The System Administrators determine if the presentation update requires an update to the Portable ERT 634. If necessary the Portable ERT software is updated 636. Otherwise, the process is complete and the online system is updated 638.

Portable ERT updates are labeled with incremental version numbers and each update sent to a First Responder is tracked with a unique serial number. Once the Portable ERT software is updated an update alert is sent 640 to First Responders. The First Responders then update 642 their current Portable ERT device either by some secure means such as a direct upload over a secured data connection or by physical device exchange.

While the update process is shown with respect to Building Staff and First Responders, Property management can interact and contribute at any point within this process. Additionally, First Responders can also initiate this process by updating First Responder relevant data on the system (e.g., Fire Department regulations, contact information, or emergency alerts.)

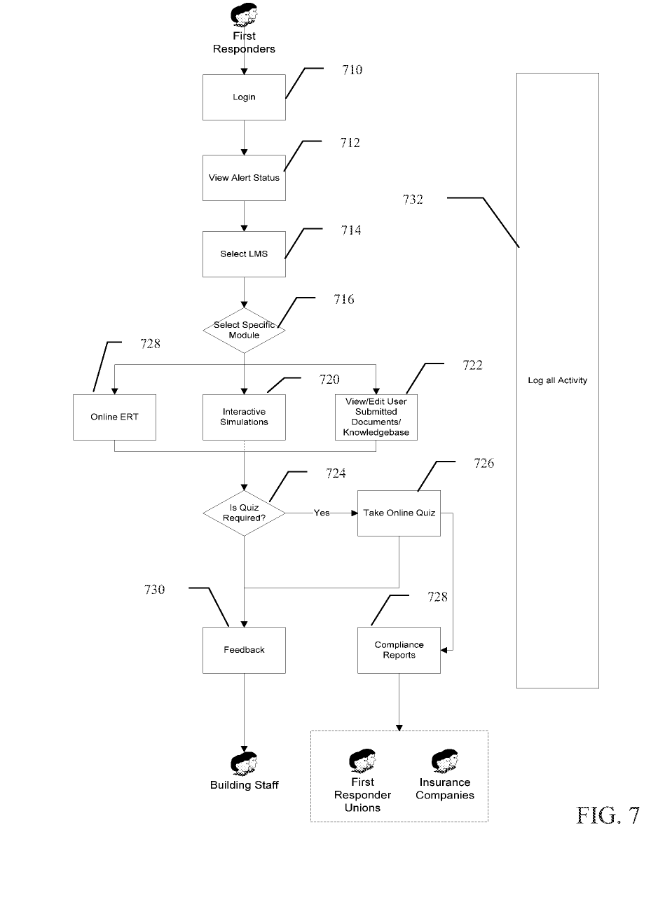

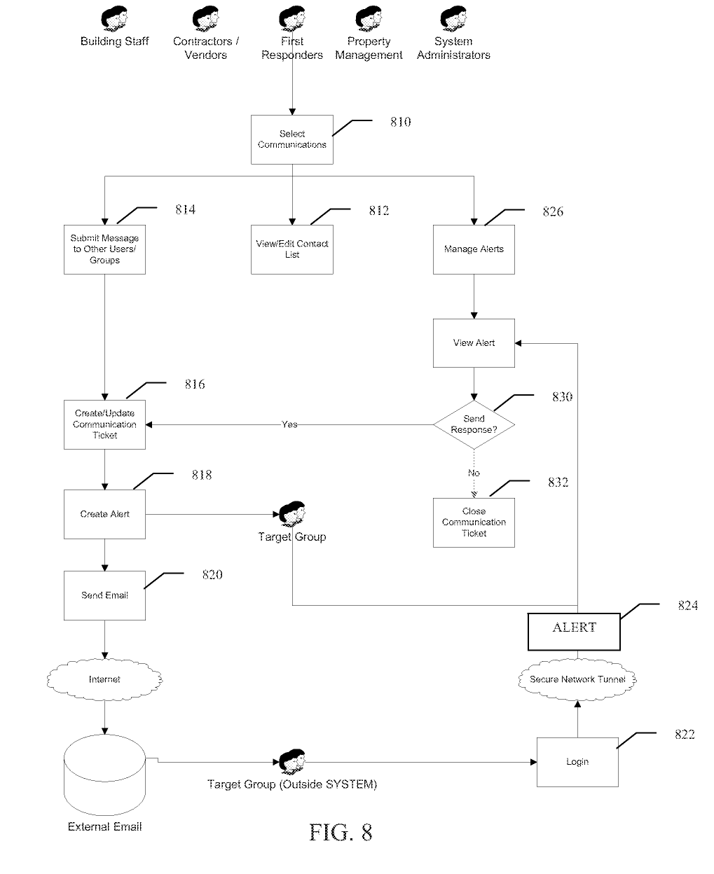

FIG. 7 demonstrates the relationship of exemplary elements of the LMS for training and compliance monitoring. To initiate training, a user, in the case shown in the flow chart a First Responder, logs into the system 710. The system displays alert status 712, if applicable. The user selects LMS 714 and selects a specific module 716—Online ERT 718, Interactive Simulations 720, View/Edit User Submitted Documents or Knowledge base 722. The Knowledge base contains a dynamic, user controlled information repository to store any useinl information relevant to the building such as building system idiosyncrasies. User submitted documents may include any digital reference material relevant to building maintenance such as building system manuals or Fire Department documents.

After the selected module is completed the system checks if a quiz is required to verify knowledge retention 724. If a quiz is required, it is administered 726.

Upon completion of quiz, results are recorded and compliance reports 728 can be generated upon these results which are viewable by relevant industry partners such as First Responder Unions or insurance companies. The user can submit feedback 730 to other user groups (System Administrators, etc.) based upon their online experience. This process can be initiated by Building Staff, First Responders, System Administrators, and Property Managers. All activity in the LMS is logge 732 to provide a comprehensive record of system usage.

The integrated communications module 26 provides dedicated alerting and change configuration control communication for the system. FIG. 8 discloses the operative elements of the system for a current embodiment. A user (from any privileged user group) selects the communication menu item 710 thereby entering the system's communication module. The user can view/edit the contact list 712. This is a list of users relevant to that particular building or property. The user can employ the Send Message function 714.The user creates the message and the system creates a Communication Ticket 716 specifically for that new message. The Ticket will be used for tracking the history of the message and any responses. Once the Ticket and the Message are completed an Alert 718 is sent to the target users. The system generates and sends a copy of the message as an email 720 to users outside the system.

If alerted by email, the target user can login 722 or if notified by an alert while on the system, can view the alert and respond to the alert by either selecting the alert at initial welcome screen 724 or by accessing the Manage Alerts 726 section in the Communications Module. The alert can then be viewed 728.

The user can Manage Alerts, view Alerts and if required the user can respond to the alert 730 which updates the Communication Ticket. Alternatively, if appropriate, the user can close the Communication Ticket 732.

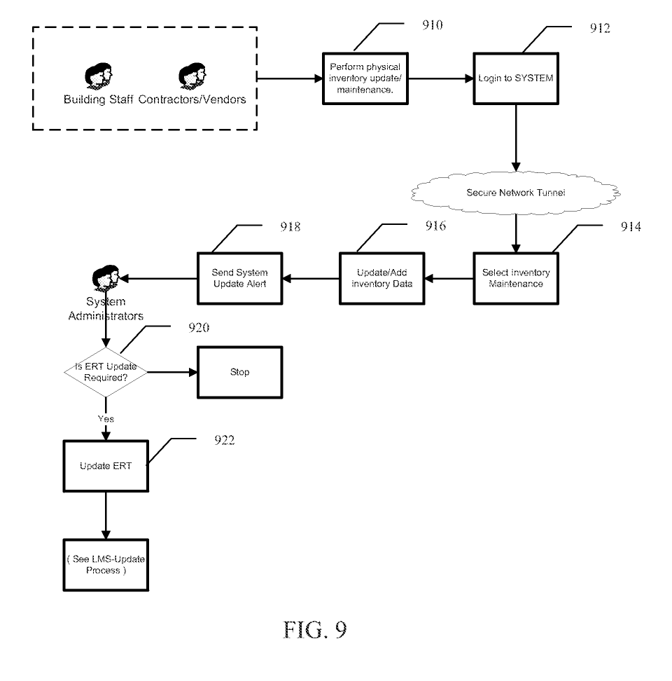

The inventory maintenance module 20 provides for updates to the system for consumable materials, hazardous products or other information for the building important for preparedness by first responders in emergency situations. As shown in FIG. 9, users (Building Staff or 3^{rd} party contractors working for building management) perform routine physical maintenance on building support systems such as fire alarms, sprinklers, control panels, etc. To employ the inventory maintenance module, users perform a physical inventory or maintenance update 910 and then log into the system 912. The users select the Inventory Maintenance menu item 914 and then update or add new inventory information 916 such as item name, make, version number, serial numbers, location, digital images, purchase history, vendor, testing and maintenance history.

The system sends an Inventory Update Alert 918 to System Administrators. The System Administrators determine if the new inventory update warrants an update to the Emergency Response Tool 920. If any update is necessary, the ERT is updated 922.

The system then performs subsequent steps identical to the UNIS Update procedure previously described. Once the ERT is updated, review requests or ERT change alerts are sent to Building Staff. Once changes are approved, First Responders are alerted to upgrade their current Portable ERT.

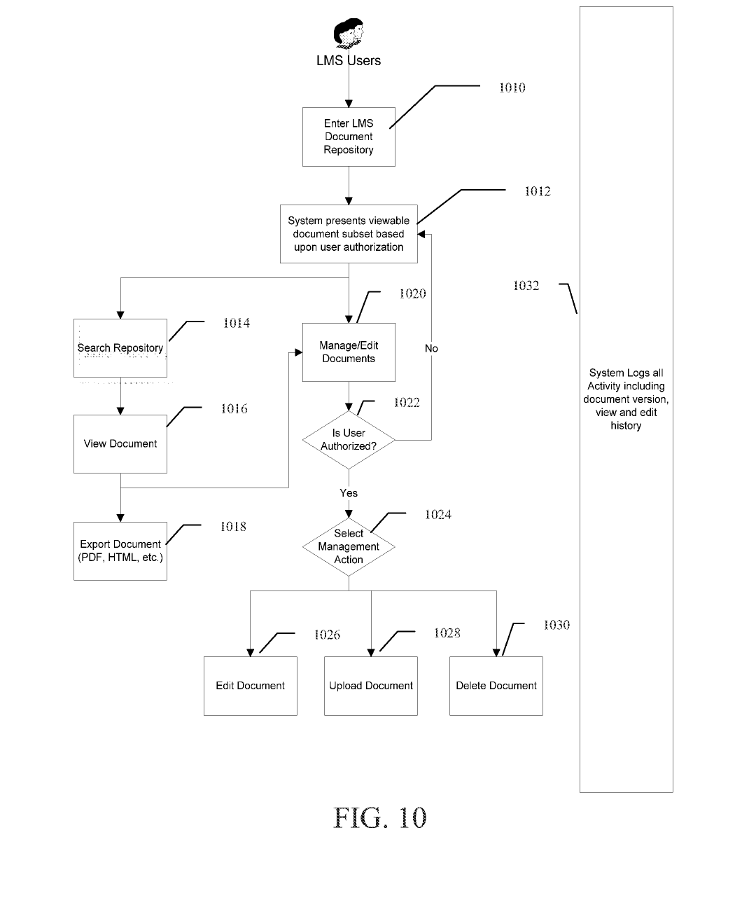

As shown in FIG. 10, the exemplary embodiment of the invention incorporates an LMS Document Repository. Summarizing the use of the repository, users enter the Document Repository 1010 and the system provides search and browsing options specific to a user's authentication parameters 1012 from which the user can search for specific documents 1014. The system provides a result set based upon search criteria and the user can view selected documents 1016 and export document to various formats such as PDF, HTML, JPEG 1018. If a user selects to manage a selected document 1020, the system verifies USER authorization 1022. If authorization permits document management, the system will allow all or a subset of management capabilities 1024 which allows the user to edit an existing document 1026, upload new documents 1028 or delete existing documents from the repository 1030.

The system records all user initiated activities including document version control, view history, and edit history 1032. The system periodically updates and refines its document catalog to improve search efficiency.

Having now described the invention in detail as required by the patent statutes, those skilled in the art will recognize modifications and substitutions to the specific embodiments disclosed herein. Such modifications are within the scope and intent of the present invention as defined in the following claims.

What is claimed is:

1. An emergency and disaster preparedness implementation system comprising:
an integrated computer system having
a network interface (14);
at least one terminal (12) for user interface to the system communicating through the network interface;
a security management module (220) included in the system and receiving communications from the at least one terminal for user authentication and connecting an authenticated user into the system;
a communications module (26) providing an active alert system for all users of communications posted on the system and having means for setting an alert for a communication sent by a user (622);
an admin console (16) for management of system functions, the admin console operable from the system by a user properly authenticated by the security management module;
a learning management system (LMS) (18) operable from the system by a user properly authenticated by the security management module, the learning management system incorporating a plurality of function specific databases (418-440) accessible for training and including training logging capability; and,
a portable emergency response tool (ERT) (12) operable independently or through the network interface, the ERT having at least a portion of the plurality of function specific databases integrally stored thereon, said ERT operable for emergency response and training.

2. The emergency and disaster preparedness implementation system as defined in claim 1 wherein the integrated computer system further comprises:
a content update and revisions module (22) interfaced to the LMS and operable from the at least one terminal by a user properly authenticated by the security management module.

3. The emergency and disaster preparedness implementation system as defined in claim 1 wherein the integrated computer system further comprises:
an inventory management module (20) interfaced to the LMS and operable from the at least one terminal by a user properly authenticated by the security management module.

4. The emergency and disaster preparedness implymentation implementation system as defined in claim 1 wherein the integrated computer system further comprises:
a document repository (24) accessible from the at least one terminal by a user properly authenticated by the security management module,

5. The emergency and disaster preparedness implementation system as defined in claim 1 further comprising:
a report generation module interfaced to the LMS to provide compliance and monitoring reporting information to all users including insurance company users and first responder unions.

6. The emergency and disaster preparedness implementation system as defined in claim 1 wherein the LMS includes interactive simulations accessible to first responders.

7. The emergency and disaster preparedness implementation system as defined in claim 5 wherein the LMS includes a quiz generator and recorder, said report generation module responsive to the quiz generator and recorder.

8. The emergency and disaster preparedness implementation system as defined in claim 2 wherein the content update and revisions module issues a change alert responsive to any modification of an LMS database.

9. The emergency and disaster preparedness implementation system as defined in claim 8 further comprising an approval module responsive to the change alert, said approval module issuing an update alert for changes to the LMS responsive to an approval.

10. The emergency and disaster preparedness implementation system as defined in claim 9 further comprising an ERT update module responsive to the approval module, said ERT update module including a notification module for first responders to update an ERT.

11. The emergency and disaster preparedness implementation system as defined in claim 2 wherein the content update and revisions module includes:
a change alert module issuing a communication to first responders and administrative personnel for any proposed change to the LMS;
a change acceptance module including a presentation change requirement alert;
a presentation modification module responsive to the change acceptance module and having a change approval alert; and,
ERT update module responsive to the change approval alert, said ERT update module including a notification module for first responders to update an ERT.

12. The emergency and disaster preparedness implementation system as defined in claim 1 wherein the LMS further incorporates an inventory maintenance update module, said inventory maintenance update module issuing an update alert upon modification.

13. A learning management system (LMS) for an emergency and disaster preparedness implementation system comprising:
a plurality of function specific databases accessible for training and including training logging capability;
a report generation module interfaced to the LMS to provide compliance and monitoring reporting information to all users including insurance company users and first responder unions, said report generation module responsive to a quiz generator and recorder;
interactive simulations accessible to first responders;
a content update and revisions module operable from the at least one terminal by a user, said contend update and revisions module issuing a change alert responsive to any modification of LMS database;
an approval module responsive to the change alert, said approval module issuing an update alert for changes to the LMS responsive to an approval.

14. The learning management system for an emergency and disaster preparedness implementation system as defined in claim 13 wherein the LMS is accessible by portable emergency response tools (ERT) and further comprising:
un ERT update module responsive to the approval module, said ERT update module including a notification module for first responders to update an ERT.

15. An emergency and disaster preparedness implementation system comprising:
an integrated computer system having
a network interface;
at least one terminal for user interface to the system communicating through the network interface;
a security management module included in the system and receiving communications from the at least one terminal tbr user authentication and connecting an authenticated user into the system;
a communications module providing an active alert system for all users of communications posted on the system and having means for setting an alert for a communication sent by a user;
admin console for management of system functions, the admin console operable from the system by a user properly authenticated by the security management module;
a learning management system (LMS) operable from the at least one terminal by a user properly authenticated by the security management module, the learning management system incorporating
a plurality of function specific databases accessible for training and including training logging capability;
a report generation module interfaced to the LMS to provide compliance and monitoring reporting information to all users including insurance company users and first responder unions, said report generation module responsive to a quiz generator and recorder;
interactive simulations accessible to first responders;
a content update and revisions module operable from the at least one terminal by a user, said contend update and revisions module issuing a change alert responsive to any modification of an LMS database;
an approval module responsive to the change alert, said approval module issuing an update alert for changes to the LMS responsive to an approval; and,
a portable emergency response tool (ERT) operable independently or through the network interface, the ERT having at least a portion of the plurality of function specific databases integrally stored thereon, said ERT operable for emergency response and training, said LMS having an ERT update module responsive to the approval module, said ERT update module including a notification module for first responders to update an ERT.
